(19) United States
(12) Patent Application Publication
(10) Pub. No.: US 2016/0063640 A1
(43) Pub. Date: Mar. 3, 2016

(54) Systems And Methods For Verification Of Vehicle Mileage Readings

(71) Applicant: Martin Ellingsworth, Dana Point, CA (US)

(72) Inventor: Martin Ellingsworth, Dana Point, CA (US)

(21) Appl. No.: 14/836,887

(22) Filed: Aug. 26, 2015

Related U.S. Application Data
(60) Provisional application No. 62/041,783, filed on Aug. 26, 2014.

(51) Int. Cl. G06Q 40/08; G06K 9/52; G06K 9/18; H04N 7/18; G07C 5/08; G06K 9/62

(52) U.S. Cl. CPC G06Q 40/08; G07C 5/085; G06K 9/6201; G06K 9/18; H04N 7/18; G06K 9/52

(57) ABSTRACT

Systems and methods for verifying an odometer reading of a vehicle are described. Images of an odometer can be obtained and analyzed to verify authenticity of the images or assign a confidence value to each image representing a likelihood of authenticity of the odometer value. An insurance quotation can be provided based on the odometer reading and optionally the confidence value, such that a user can received discounted insurance for lower than average driving habits.

This application claims priority to U.S. provisional application Ser. No. 62/041783, filed Aug. 26, 2014. All extrinsic materials identified herein are incorporated by reference in their entirety.

1. Field of the Invention

The field of the invention is verification systems and methods.

2. Background

The background description includes information that may be useful in understanding the present invention. It is not an admission that any of the information provided herein is prior art or relevant to the presently claimed invention, or that any publication specifically or implicitly referenced is prior art.

Despite the prevalence of smart phones and other portable computing devices, the process for selecting and obtaining insurance, and particularly vehicle insurance, has not adapted to take advantage of today's technology. For example, with the increase of smart phones (e.g., network-enabled devices with various sensors that are able to run sophisticated software), consumers are able to utilize their phones for a variety of different purposes including taking photos, running various programs, and accessing remote networks.

There have been some developments in filing claims with insurance companies. For example, U.S. Pat. No. 8,019,629 to Medina, III et al. discusses taking a photo of a vehicle's license plate number, for example, and submitting those photos electronically to an insurer when filing a claim. While such system allows for more efficient processing of insurance claims, it fails to improve the process for consumers to update odometer readings and shop for insurance based on mileage, something that is lacking today.

Although U.S. pat. publ. no. 2010/0088123 discusses that a consumer could take a photograph of an odometer to submit to an insurance company, such process appears to lack sufficient safeguards to verify accuracy of the odometer reading and fails to provide consumers with a usable database of readings that could be used to evaluate insurance carriers, for example.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Thus, there is still a need for improved systems and methods for verifying odometer readings and enabling consumers to more easily compare insurance rates based on their mileage.

### SUMMARY OF THE INVENTION

The present invention provides apparatus, systems, and methods for verifying an odometer reading of a vehicle and/or providing insurance of a vehicle to a user based on individual driving habits (e.g., miles driven) of the vehicle to be insured.

In one aspect of the inventive subject matter, a system includes a user interface that is configured to capture an image containing a vehicle's odometer. It is contemplated the user interface could be installed on a portable computing device such as a smart phone. In such embodiments, the image can be captured and uploaded to a remote server via the portable computing device. As used herein, the term “portable computing device” is defined to include laptops, netbooks, tablet computers, and other portable computers, mobile and smart phones, smart watches, personal digital assistants, MP3 players, and any other portable device having some form of network connectivity to allow for exchange of data.

The system can include a verification engine that can receive the image and/or data related to the image, and extract an odometer value or reading from the image. The image and/or data can be analyzed by the verification engine using one or more verification algorithms to generate a confidence value representing a likelihood of accuracy and/or authenticity of the odometer value in the image.

A quotation for insurance of the vehicle can be presented to the user via the user interface, for example, where the quotation is based on the confidence value and at least some of the data.

In another aspect of the inventive subject matter, a method for verifying an odometer reading of a vehicle includes providing a user interface configured to capture an image that includes an odometer of a vehicle. Preferably the user interface is presented on a portable computing device such as a smart phone, and could be in the form of an application or a website, for example.

The image and/or data related to the image can be received, and an odometer value can be extracted using a verification engine. The image and/or data can be analyzed using the verification engine to generate a confidence value representing a likelihood of authenticity of the odometer value. The confidence value can then be associated with the odometer value.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIGS. 1-2 are diagrams of embodiments of systems for verifying an odometer reading of a vehicle.

FIG. 3 is a flowchart of one embodiment of a method for verifying an odometer reading of a vehicle.

FIG. 4 is one embodiment of a user interface of a VIN request screen.

FIG. 5 is one embodiment of a user interface of a home screen.

FIG. 6 is one embodiment of a user interface to capture a VIN.

FIGS. 7-9 are embodiments of user interfaces to verify a VIN.

FIG. 10-12 are embodiments of user interfaces to capture and verify an odometer reading.

FIG. 13 is an embodiment of an insurance agent contact interface.

FIG. 14 is an embodiment of an odometer reading verification page.

FIG. 15 is embodiments of user interfaces for capturing and verifying an odometer reading.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided herein is prior art or relevant to the presently claimed invention, or that any publication specifically or implicitly referenced is prior art.

The inventive subject matter provides apparatus, systems and methods in which a user can quickly and easily submit a mileage verification to a local database (such as on a smart phone or other computing device) or to a remote database (such as that of an insurer or other third party). In one embodiment, a user can utilize a portable computing device, such as a smart phone, to capture and authenticate a vehicle's odometer reading. This can be done as often as desired or required, and could be on an annual basis, a bi-annual basis, monthly, weekly, or even on a per-use basis of the vehicle, such as for loss control in a commercial policy, for example.

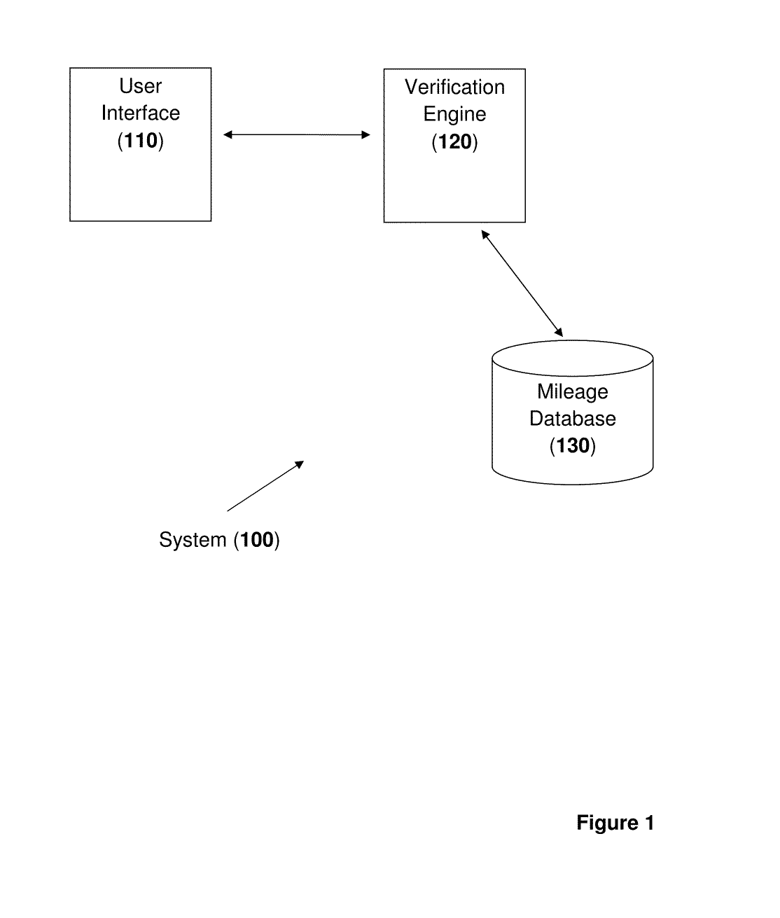

As shown in FIG. 1, system 100 for verifying an odometer reading of a vehicle can comprise a user interface 110 configured to capture an image that includes the vehicle's odometer.

In some embodiments, if accessing the user interface 110 for the first time, or at other specified triggers, the user interface 110 may request the user to input the vehicle identification number (VIN) of the vehicle. This can be done manually via a keyboard or preferably by capturing an image of the vehicle's VIN, which may be located on the vehicle itself, on a vehicle registration card, or on an insurance card, for example. Where an image is taken, the image can be analyzed and the VIN extracted from the image, such as via OCR or other known process(es). In addition to simply requesting a user to verify the information entered or extracted, the VIN can be parsed and run against known checksum schemes to verify accuracy of the VIN. This includes, for example, verifying that the VIN contains 17 characters, verifying the check digit of the VIN, reviewing for invalid characters (e.g., the letters I (i), O (o), Q (q), U (u) or Z (z), and the number 0) and so forth, and verifying that the VIN corresponds with the make of the vehicle.

After the VIN is inputted via the user interface 110, the interface 110 can present a request to the user to obtain the vehicle's odometer reading by capturing an image of the odometer. Once taken, the user is preferably asked to verify the odometer reading presented, which could include requesting the user to review and click to accept, or requesting the user to manually enter the odometer reading shown in the image.

A verification engine 120 can receive the image and/or data related to the image, and extract an odometer value (e.g., the mileage of the vehicle as shown in the image). The verification engine can also analyze the image, odometer value, sensor data, and/or other data using one or more verification algorithms such that a confidence value can be associated with the odometer value. In preferred embodiments, the confidence value represents the likely accuracy of the odometer value for that vehicle as defined by the verification algorithms.

Such analysis involves one or more processes, which can include, for example, third party verification (e.g., a manual review), machine review with other databases of VIN with odometer readings, and algorithms to authenticate/verify the odometer reading of the vehicle via a tamperproof photo capture algorithm at the point of capture or on a distal server. The verification engine 120 can also request the user to certify the reading via the user interface prior to the reading being transmitted to a third party or, when applicable, before being recorded to the local database.

Such processes could also utilize sensor information from a portable computing device of the user that preferably presents the user interface. Such information includes, for example, location information. For example, if the photograph was taken in a different state than where the user is domiciled, this may flag the image or data for further review or verification by an insurer. It is also contemplated that the processes could analyze the amount of time passed since a previous odometer reading had occurred, and then generate a value indicating the likelihood that the odometer reading is accurate based on average driving habits or driving habits of the vehicle's driver.

It is especially preferred that the verification engine 120 is configured to run a cascading audit of the entered data, which may include, for example, recognition algorithms with accuracy estimates on the string, manual remote repair or replace using single and/or a double-blind verification audit, and an image comparison process to reflect the subsequent photos are consistently from the same style of odometer as the initial used photo. In addition, the audit may include a process of requiring the use of a device registered to the user submitting the image of the odometer. For example, the image itself that includes the odometer reading could also be analyzed and compared with prior images taken to determine whether the automobile is the same, for example, based on the look of the odometer and surrounding surfaces and/or other components. Additionally, time sequencing of “reminded events” at short intervals (e.g., at 0/30/60/90 days on initiation) and routine intervals (e.g., 90 days to keep miles data fresh) will compare a consistency monitor of both the miles used profile, the unique ID combination of device plus the VIN, and other signature characteristics of odometer style, operator compliance and account authentication at the point of data submission.

It is further contemplated that data may be correlated over time with a variety of third party odometer data sources which are often associated with a VIN (e.g., mechanical service, insurance claim, accident report, routine service, compulsory safety or environmental compliance inspections, title reports or registrations, telematics readings, or other data sources).

It is contemplated the user interface 110 can be configured to capture a second image, and additional subsequent images over time, that includes the odometer of the vehicle, such that periodic mileage of the vehicle can be quickly and easily documented.

In such embodiments, the verification engine 120 can be configured to receive data related to the second image, and extract a second odometer value from the data. The verification engine can compare at least one of (i) the images and (ii) data from the images, and associate a confidence value with the second odometer value based on a likelihood that the odometer in the image is the same as the odometer of the second image (e.g., that it is from the same vehicle and subsequent in time).

Via the user interface or other mechanism, a quotation for insurance for the vehicle can be presented to the user based on the confidence value and at least some of the data, which may include the odometer value, for example, and/or traditional factors for insurance pricing such as driver age, gender, driving habits, past accidents or convictions, make, model and year of car, location garaged and other information. In other contemplated embodiments, a user's current insurance pricing can be adjusted based on the confidence value and at least some of the data. Where multiple images of the odometer have been taken, the user interface 110 can be further configured to present the quotation for insurance based on the confidence value and the second confidence value, and at least some of the data.

In still further contemplated embodiments, the user interface 110 can be further configured to submit the data to an insurance exchange and request a quotation for insurance of the vehicle if the confidence value is greater than a predefined threshold.

System 100 can further include a mileage database 130 that is configured to receive and store the image and the data. In this manner, past data, confidence values, and/or odometer values can be used to calculate a quotation for insurance or seek insurance quotations from vendors. The mileage database 130 could be locally stored on the portable computing device or stored remotely on a distal server. With the odometer reading, the latitude and longitude can also be recorded, and the entry can be time- and date-stamped along with the portable computing device's unique ID signature, if applicable.

It is contemplated that system 100 could be further communicated to communicate directly with the vehicle to verify mileage such as by sending a control signal to the vehicle and receiving a return signal that is based at least in part on the control signal. In such embodiments, it is contemplated that the user could be required to take some action in the vehicle itself to have the return signal sent and thereby verify that the user is present in the vehicle.

Via the user interface 110, the user can preferably contact a selected insurance company via email, text, or telephone, as appropriate. The user can also submit one or more odometer readings to an insurer upon request or to demonstrate driving habits. This information could be used, for example, with the user's current insurer to verify driving habits (e.g., number of miles driven per year), but could also be used to shop around for insurance by providing potential insurers with a verified amount of miles driven by the user.

Although most insurers currently base insurance rates on various tiers regarding how many miles are driven per year (e.g., less than 5,000 miles; 5001-7,500 miles, and so forth), this system advantageously allows users to price auto insurance based on the precise number of miles they drive, which could be verified on a periodic basis (e.g., daily, weekly, monthly, etc.). Because of the ease of recording an odometer reading by using a device likely already carried by the user, the system encourages frequent recordation of mileage reading (as many in a day as the user desires) for logging trips and other permitted uses. Because the information is stored in a database, which may be local to the device or on a distal server, the user can utilize that information for future reporting to an insurer, for example. The past driving habits could also be utilized for mileage logs, which can be useful to delineate between personal driving and that for business. It is especially contemplated that the system could allow for tagging of the mileage to allow a user to document the purpose of the miles.

Furthermore, the mileage database 130 where the mileage information can be stored allows easy access to the data from virtually anywhere and on any device. This greatly simplifies the process for shopping for better-priced insurance products, and re-underwriting for insurers as they refine their mileage bands for consumers or calculate prorated mixed use vehicle premium splits for personal/commercial use of household vehicles (e.g. Uber™, Lyft™, etc). For commercial fleets of vehicles, the system can be utilized for driver/vehicle assignment tracking and rating.

In an exemplary scenario, a retiring commuter with 50 years of claims-free driving history and a perfect underwriting profile sees practically no benefit when changing from a work day 15,000 miles per year driving habit to her retiree 4,000 miles per year driving habit. She also likely has many other policies bundled into her risk transfer coverage, but the change in driving exposure is a significant event. For other consumers, they may not drive the traditional 12,000-15,000 miles per year, and would otherwise likely participate in a pay-as-you-drive program such as that described herein.

The system described herein advantageously lowers data acquisition costs of insurers/brokers by reducing or eliminating the need for paper mail to request yearly or biannually odometer readings, data entry associated with the responses received, improving the accuracy and timeliness of underwriting data by encouraging additional odometer readings throughout the year, engaging policy holders to comply with discount programs, attracting new business where lower risk is priced better, retaining customers who have a change in miles used with graduated price points, and optionally adding other valued-added personalized offers and services based on make/model/mileage information.

Via an application or other interface, users can be reminded to capture an image of the vehicle's odometer at predetermined times throughout the year to ensure compliance with the insurance program they selected.

In another contemplated embodiment shown in FIG. 2, a system 200 for mileage verification of a vehicle includes a mileage engine 220 that is configured to receive first and second images of a vehicle's odometer from a portable computing device of a user.

System 200 can further include a check engine 230 that verifies the odometer reading by analyzing data associated with the image and at least one of the portable computing device, the second image, and metadata using one or more verification algorithms to generate a confidence value for the odometer values. The confidence value can then be associated with the odometer values by the check engine 230.

In some contemplated embodiments, the check engine 230 can be further configured to verify the odometer reading by comparing the odometer shown in the first image with the odometer shown in the second image, and wherein the confidence value is based at least in part on a result of the comparison.

If the confidence value is greater than a predefined threshold, a quotation for insurance can be requested from one or more insurers and/or a quotation for insurance can be presented to the user via a user interface. It is contemplated that the quotation can be based on the confidence value and at least some of the data.

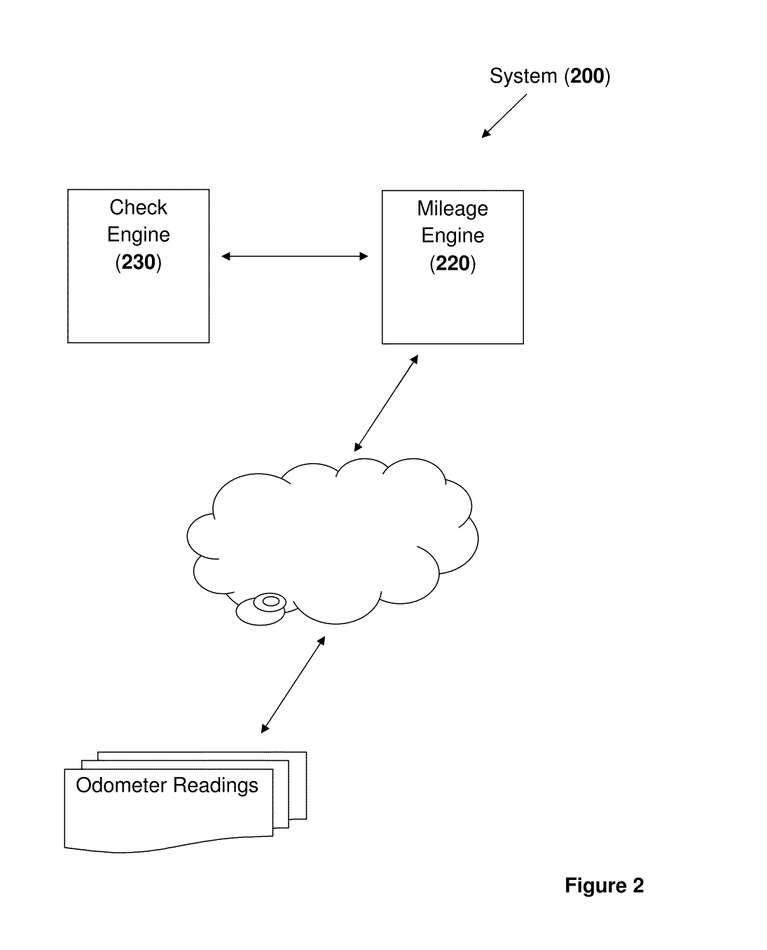

FIG. 3 illustrates one embodiment of a method 300 for verifying an odometer reading of a vehicle. In step 310, a user interface is provided that is configured to capture an image that includes a vehicle's odometer. Capture of the image can include the various manners and processes discussed above.

The image or data related to the image can be received in step 320, and an odometer value can be extracted, for example, by using a verification engine. In some embodiments, the image, odometer value, and/or data associated with the image can be stored in a mileage database in step 322.

The image or data can be analyzed in step 330 using the verification engine to generate a confidence value representing a likelihood of authenticity of the odometer value, and the confidence value can be associated with the odometer value in step 340. It is contemplated that the analysis in step 330 could include comparing the odometer from the first image and the odometer from the second image to generate the second confidence value in step 332.

Preferably, a second image of the odometer can be captured on a subsequent date in step 312, and the second image can be analyzed using the verification engine to generate a second confidence value representing a likelihood of authenticity of the second odometer value.

In step 350, based at least in part on the confidence value and the odometer value, a quotation for insuring the vehicle can be presented to the user in a similar manner to that described above. Where multiple confidence values are present, the values can be averaged or a collective value can be determined based on a predefined algorithm, and the quotation for insurance can be at least partially based on the collective or average confidence value or the many confidence values. In some embodiments, it is contemplated that the odometer value is only used/stored if the confidence value is greater than a predetermined threshold.

Where additional odometer readings are captured over time, it is contemplated that a quotation or contract for insurance can be adjusted based on at least one of the likelihood of authenticity and the odometer value from the second image.

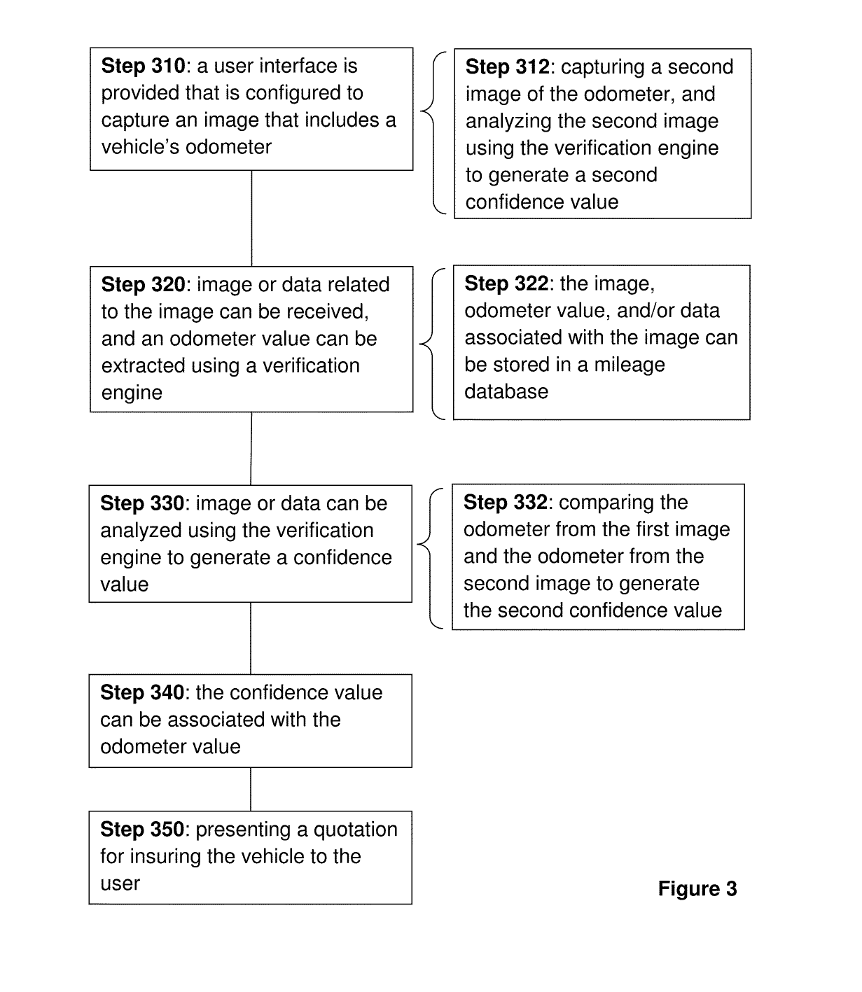

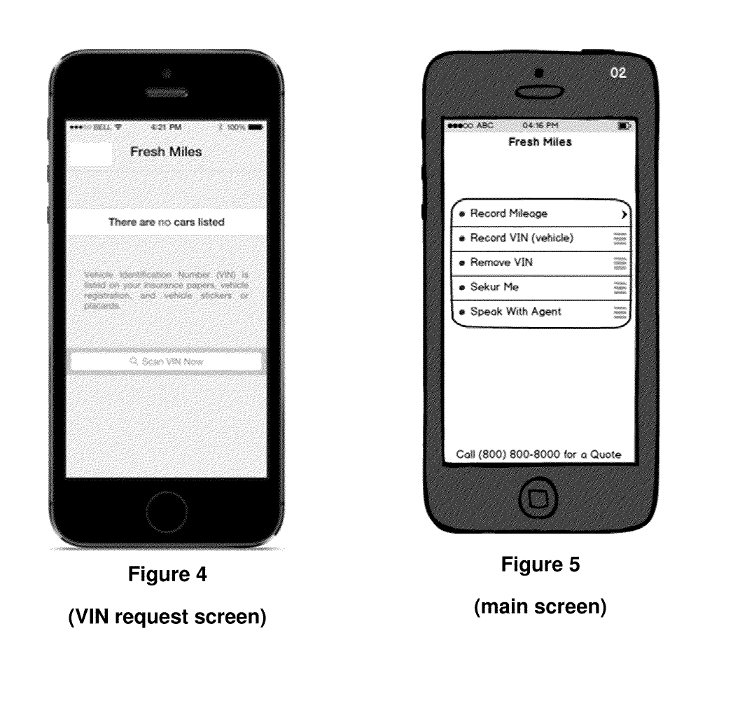

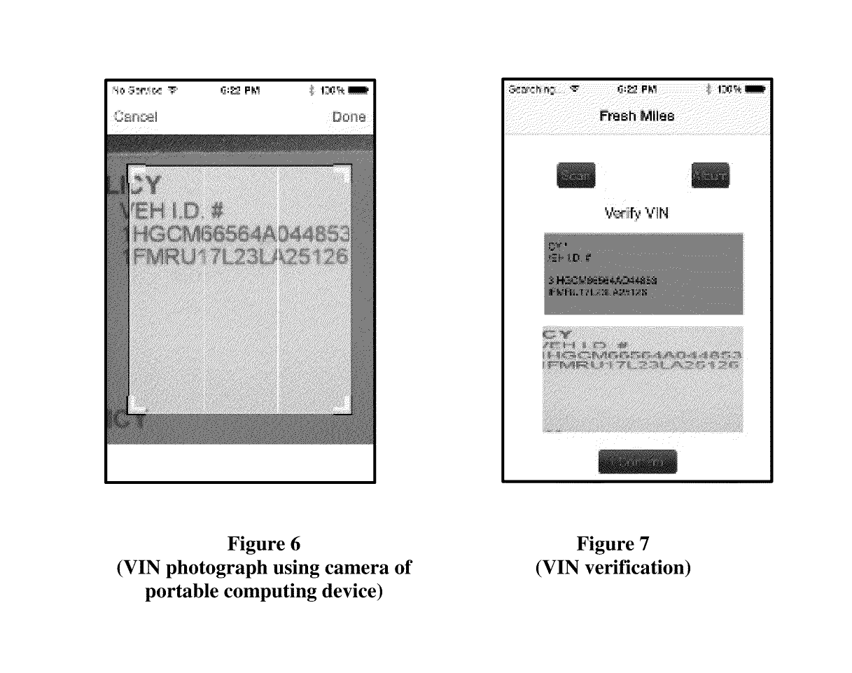

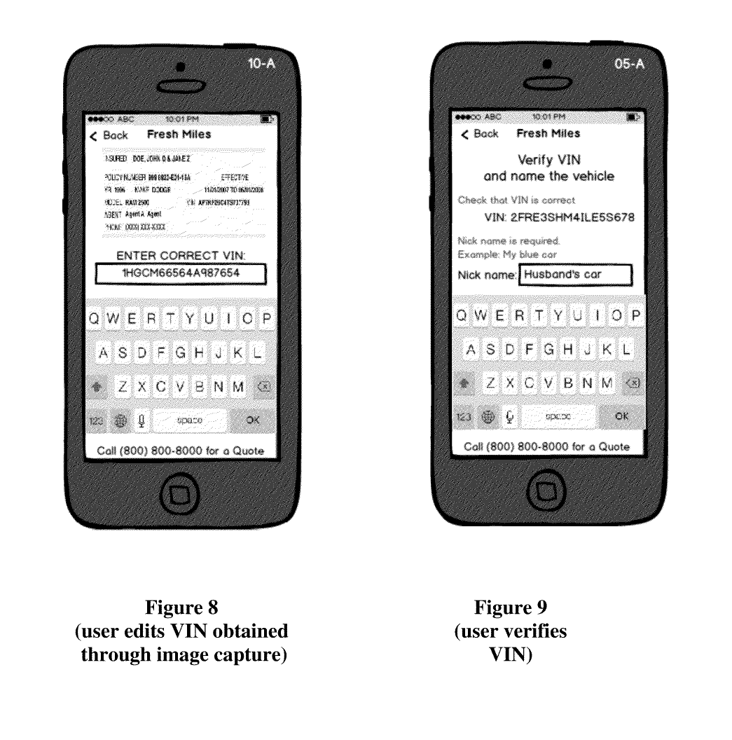

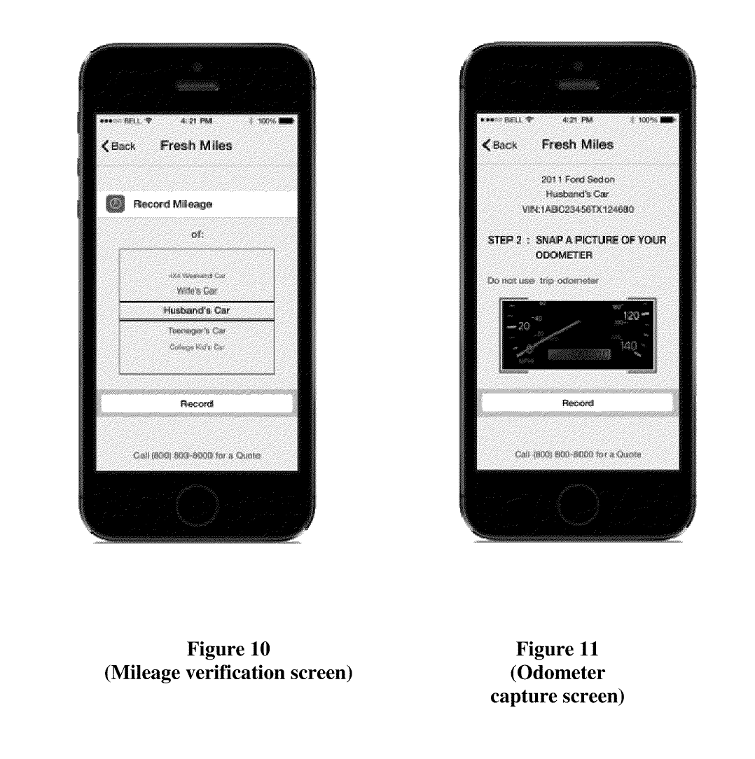

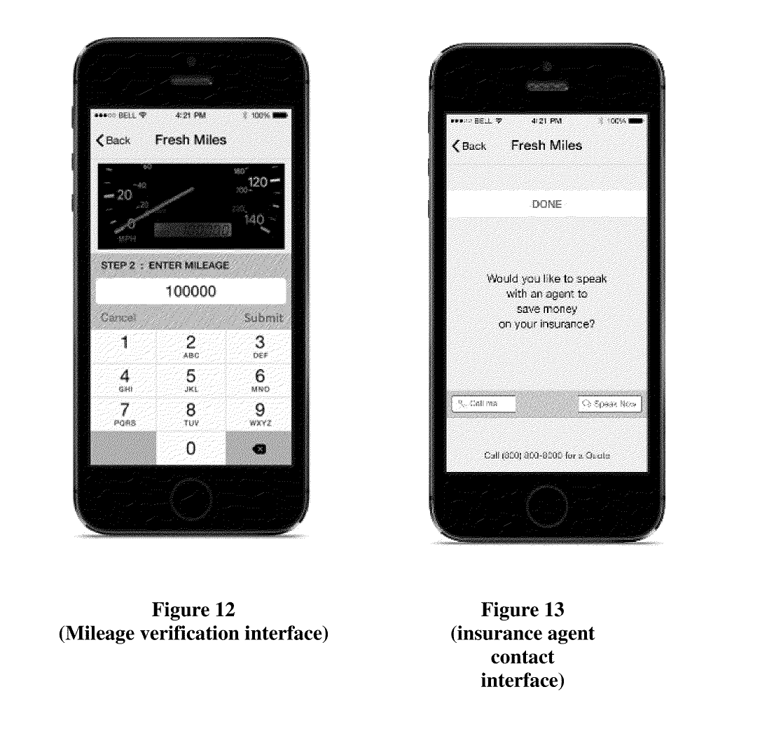

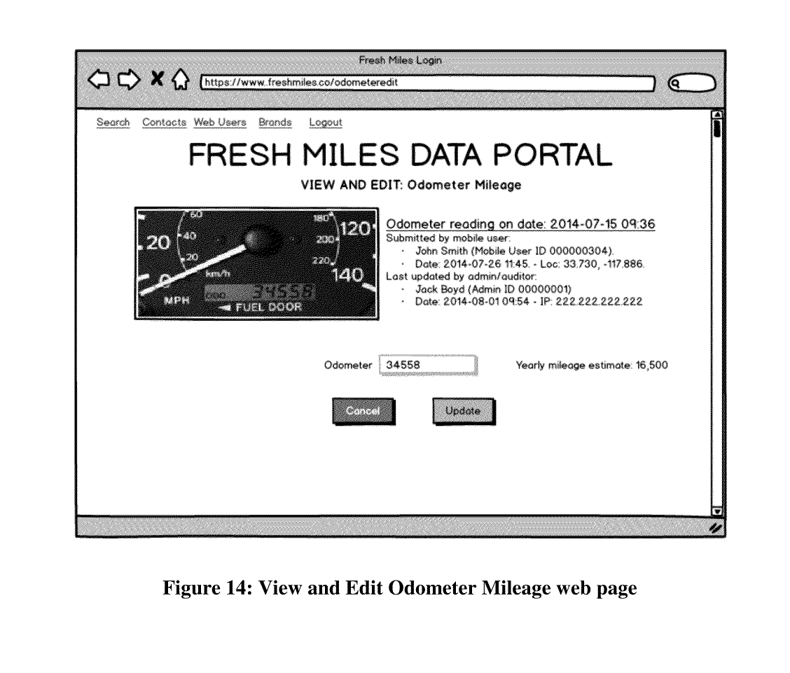

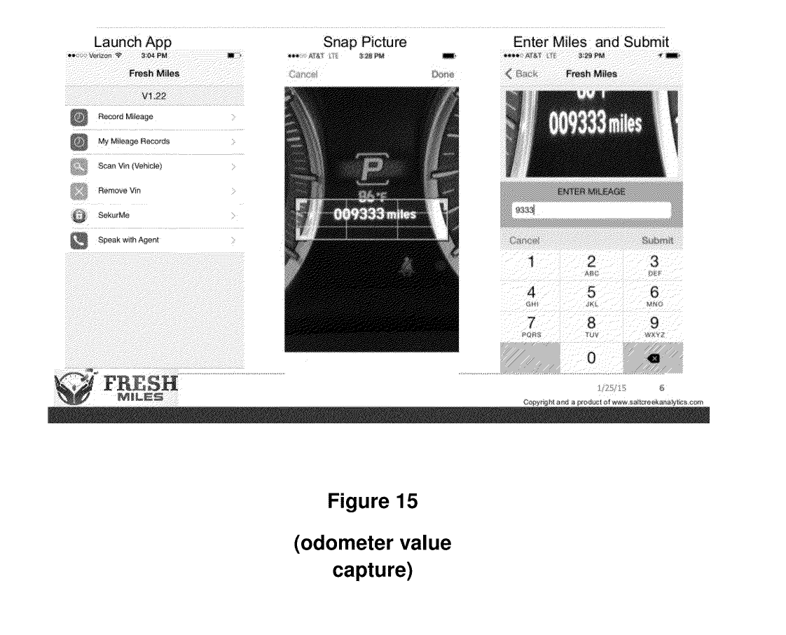

In some contemplated embodiments, a user can open a software application or navigate to a designated website on a portable computing device. FIGS. 4-15 are exemplary embodiments of user interfaces for user with the systems and methods herein.

Thus, exemplary embodiments of systems and methods for verification of insurance parameters have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for verifying an odometer reading of a vehicle, comprising:
a user interface configured to capture an image that includes an odometer of a vehicle;
a verification engine configured to receive data related to the image, and extract an odometer value from the data;
wherein the verification engine is further configured to analyze the data using one or more verification algorithms, and associate a confidence value with the odometer value; and
wherein the user interface is further configured to present a quotation for insurance of the vehicle based on the confidence value and at least some of the data.

2. The system of claim 1, further comprising a mileage database configured to receive and store the image and the data.

3. The system of claim 1, wherein the user interface is configured to capture a second image that includes the odometer of the vehicle, and wherein the verification engine is configured to receive data related to the second image, and extract a second odometer value from the data.

4. The system of claim 3, wherein the verification engine is further configured to compare at least one of (i) the image and the second image and (ii) the data from each of the image and second image, and associate a second confidence value with the second odometer value based on a likelihood that the odometer in the image is the same as the odometer of the second image, and wherein the user interface is further configured to present the quotation for insurance based on the confidence value and the second confidence value, and at least some of the data.

5. The system of claim 3, wherein the quotation is further based on a difference between the second odometer value and the odometer value.

6. The system of claim 1, wherein the user interface is further configured to submit the data to an insurance exchange and request the quotation if the confidence value is greater than a predefined threshold.

7. The system of claim 1, wherein the user interface is further configured to capture a second image that includes a vehicle identification number (VIN) of the vehicle, and wherein the verification engine is further configured to analyze data related to the second image using one or more verification algorithms, and adjust the confidence value as a result of the verification algorithms.

8. The system of claim 1, wherein the one or more verification algorithms comprises sending a control signal to the vehicle and (b) receiving a return signal that is based at least in part on the control signal.

9. A system for mileage verification of a vehicle, comprising:
a mileage engine configured to receive a first image and a second image of an odometer of a vehicle from a portable computing device of a user;
wherein the mileage engine is further configured to extract odometer values from each of the first and second images;
a check engine configured to verify the odometer reading by analyzing data associated with the image and at least one of the portable computing device, the second image, and metadata using one or more verification algorithms to generate a confidence value for the odometer values; and
wherein the check engine is further configured to associate the confidence value with the odometer values.

10. The system of claim 9, further comprising a user interface configured to present a quotation for insurance of the vehicle based on the confidence value and at least some of the data.

11. The system of claim 9, wherein the check engine is further configured to verify the odometer reading by comparing the odometer shown in the first image with the odometer shown in the second image, and wherein the confidence value is based at least in part on a result of the comparison.

12. A method for verifying an odometer reading of a vehicle, comprising:
providing a user interface configured to capture an image that includes an odometer of a vehicle;
receiving the image or data related to the image and extracting an odometer value using a verification engine;
analyzing the image or data using the verification engine to generate a confidence value representing a likelihood of authenticity of the odometer value; and
associating the confidence value with the odometer value.

13. The method of claim 12, further comprising presenting a quotation for insuring the vehicle based at least in part on the confidence value and the odometer value.

14. The method of claim 12, further comprising storing the image and odometer value in a mileage database.

15. The method of claim 12, wherein the user interface is further configured to capture a second image that includes the odometer of the vehicle, and further comprising analyzing the second image using the verification engine to generate a second confidence value representing a likelihood of authenticity of the second odometer value.

16. The method of claim 15, wherein the step of analyzing further comprises comparing the odometer from the first image and the odometer from the second image to generate the second confidence value.

17. The method of claim 16, further comprising presenting a quotation for insuring the vehicle based at least in part on the confidence value, the second confidence value, and the odometer value.

18. The method of claim 12, further comprising submitting data including the odometer value to an insurance exchange using the verification engine, and request a quotation for insurance of the vehicle if the confidence value is greater than a predefined threshold.

19. The method of claim 18, wherein the user interface is further configured to capture a second image that includes the odometer of the vehicle at a time different from the capture of the first image, and further comprising (i) analyzing the second image using the verification engine to generate a second confidence value representing a likelihood of authenticity of the second odometer value, and (ii) adjusting the quotation for insurance based on at least one of the likelihood of authenticity and the odometer value from the second image.

20. The method of claim 12, wherein the user interface is further configured to capture a second image that includes a vehicle identification number (VIN) of the vehicle, and further comprising analyzing data related to the second image using the verification engine and one or more verification algorithms, adjusting the confidence value as a function of the verification algorithms.
